(19) United States
(12) Patent Application Publication
(10) Pub. No.: US 2022/0259086 A1
(43) Pub. Date: Aug. 18, 2022

(54) Membrane Method for Making Surface Water Drinkable Without Adding Any Sequestering Agent

(71) Applicant: Veolia Water Solutions & Technologies Support, Saint-Maurice (FR)

(72) Inventors: Philippe Sauvignet, Maen Roch (FR); Henrik Gunnar Held, Kunsangen (SE); Uwe Sauer, Kulmbach (DE); Abdelkader Gaid, Paris (FR)

(21) Appl. No.: 17/618,022

(22) PCT Filed: Jun. 11, 2020
(86) PCT No.: PCT/EP2020/066193

§ 371 Date: Dec. 10, 2021

(30) Foreign Application Priority Data
Jun. 11, 2019 (FR) FR1906187

(51) Int. Cl. C02F 9/00; B01D 61/02; B01D 69/02; B01D 61/14; B01D 61/58; B01D 71/68

(52) U.S. Cl. CPC C02F 9/00; B01D 61/027; B01D 69/02; B01D 61/022; B01D 61/145; C02F 1/283; B01D 61/58; B01D 71/68; B01D 2325/20; B01D 2317/02; B01D 2311/2626; B01D 61/147

(57) ABSTRACT

Method for making surface water drinkable, which method is aimed at reducing the suspended matter content, turbidity, organic matter content and colour of the water, and is characterised in that it comprises: ●a step of nanofiltering the water (2) through at least one nanofiltration membrane (2) which has a breakdown capacity between 800 Da and 2000 Da, preferably between 800 and 1000 Da, the nanofiltration step leading to the acquisition of a permeate (7) and a concentrate (5), ●wherein the nanofiltration step is carried out with a conversion rate greater than 95%, ●the method being carried out without any step of adding an anti-scaling agent or any step of remineralising the permeate.

### DOMAINE

The field of the invention is that of making surface water drinkable.

More precisely, the invention relates to a method for making surface water (mainly river or lake water) drinkable by filtration thereof by means of membranes.

### PRIOR ART

Numerous methods for treating surface water with a view to making it drinkable are known from the prior art. The operation of making water drinkable consists in lowering the suspended matter content, turbidity, organic matter content including colour, and the micropollutant content, of the surface water.

Thus, physicochemical methods are known using chemical products for aggregating the organic matter to facilitate elimination thereof by settling. These chemical products, referred to as coagulants or flocculants, constitute consumables which, apart from the cost thereof, have the drawback of not being neutral for the environment. These chemical methods provide efficiency of elimination of the organic matter that rarely exceeds 70% despite the high doses of product injected. They are accompanied by a significant production of sludge. Moreover, they require adjusting the pH and remineralising the water because of their operating conditions in an acidic environment (pH 5.5 to 6). In addition, these methods do not treat the micropollutants.

Other methods consist in putting the water to be made drinkable in contact with a material, such as mainly activated carbon, adsorbing the organic matter, in particular the micropollutants, that it contains.

These methods do however require the use of high concentrations of adsorbent products, which makes them expensive methods. Activated carbon has a porous structure making it possible to retain a wide range of contaminants. However, the presence of a high concentration of organic matter tends to quickly saturate the macropores and some of the mesopores of the activated carbon. Even if the micropollutants continue to be adsorbed on the medium, the activated-carbon reactor then requires higher doses in order to treat the organic matter and produce water with a quality conforming to the standards. In addition, these methods involving activated carbon are not adapted for treating water having strong colouring, related to a high concentration of humic substances, since to do this they would give rise to prohibitive operating costs.

Membrane filtration methods are normally used in the context of producing drinkable water. The membranes that they use have a porous structure that enables them to retain not only matter in suspension but also dissolved matter. Thus microfiltration membranes have pores of 0.1 μm to 10 μm, ultrafiltration membranes have pores of 10 nm to 0.1 μm, nanofiltration membranes have pores of a few nanometres and reverse osmosis membranes have an even denser structure. Reverse osmosis membranes thus make it possible to retain almost all the solutes. They are widely used for producing drinkable water from sea water or brackish water.

However, these nanofiltration or reverse osmosis membrane filtration methods lead to water losses of between 15% and 30% and therefore to concentrates that cannot be discharged into the natural environment before specific treatment. In addition, the filtered water obtained by nanofiltration or reverse osmosis membranes must undergo remineralisation since passing through the membranes also eliminates bivalent ions (nanofiltration) and monovalent ions (reverse osmosis).

Moreover, nanofiltration or reverse osmosis membranes used for making water drinkable have the drawback of becoming clogged up over time and requiring the use of chemical products, referred to as anti-scaling or sequestering agents, for delaying this process. These sequestering products may be harmful for the environment.

It should also be noted that, in some regions, the surface water to be made drinkable has a more accentuated colouring than previously. This colouring, which is related to the presence of humic substances in this water, results from the degradation of the plants located in the area where the surface water is captured. Global warming would appear to be one of the causes of the accentuation of the colouring of this water. To this intensification of the colour of surface water, the current response is increasing the doses of chemical products used for reducing the organic matter content thereof, consequently causing an increase in the production of sludge.

### Objectives of the Invention

On the drinking-water market, there is an increasing need for methods not using or making only little use of chemical products. This is because these products may have a harmful effect for the environment during use thereof and/or during manufacture or transport thereof. They are therefore more and more unacceptable to the consumer.

One objective of the present invention is to propose a method for making surface water drinkable by membrane method making it possible to dispense with the use of any sequestering product.

One objective of the present invention is also to disclose such a method for making water drinkable not requiring any remineralisation of the treated water.

Another objective of the present invention is to disclose such a method for making water drinkable that, in at least some of the embodiments thereof, makes it possible also to dispense with the use of any coagulant or any flocculant.

Yet another objective of the invention is proposing such a method that leads to the production of little or no sludge.

Finally, another objective of the present invention is to propose such a method making it possible to operate the membrane systems with hydraulic efficiencies greater than those that can be obtained with the methods of the prior art.

### DESCRIPTION OF THE INVENTION

These objectives, as well as others that will emerge hereinafter, are achieved by means of the invention, which relates to a method for making surface water drinkable aimed at reducing the suspended matter content thereof, the turbidity thereof, the organic matter content thereof and the colour thereof, characterised in that it comprises:
a step of nanofiltration of said water through at least one nanofiltration membrane having a cut-off capacity between 800 Da and 2000 Da, preferentially 800 Da to 1000 Da, said nanofiltration step leading to the acquisition of a permeate and a concentrate,
where said nanofiltration step is carried out with a conversion rate greater than 95%,
said method being carried out in the absence of any step of adding an anti-scaling agent or any step of remineralising the permeate.
Thus the invention proposes to use a nanofiltration step with a very high conversion rate for filtering the surface water, while not using any sequestering product during the method. The conversion rate TC of a membrane treatment is the ratio of the flow of permeate (QP) resulting from the membrane treatment to the incoming water rate (QF) in the membrane treatment: TC=100 QP/QF.
According to a variant, said nanofiltration step is implemented in a nanofiltration plant comprising a single stage.
According to another variant, said nanofiltration step is implemented in a nanofiltration plant comprising two stages mounted in series.
According to a preferential variant, said method comprises a step of microfiltration or ultrafiltration of said water, prior to said nanofiltration step, said preliminary step being implemented through at least one microfiltration or ultrafiltration membrane having a cut-off capacity of between 10 nm and 1 μm, said ultrafiltration step and said nanofiltration step being implemented with a total conversion rate greater than 90%. In this case, the method preferentially comprises a sieving step provided upstream of said microfiltration or ultrafiltration step, said sieving step being implemented with a cut-off capacity of between 20 μm and 200 μm and preferentially between 20 μm and 50 μm, said method then being implemented in the absence of any addition of coagulant and/or flocculant product.

These screening and ultrafiltration or microfiltration steps combined with the nanofiltration make it possible in fact to reduce the suspended matter and colloidal particle content of the water and the organic matter content and in particular the colour of the water, so as to meet the current standards without having previously to add to the water coagulant and/or flocculant products to form flocs and then settling it in a settler.

When the water to be treated has micropollutants, the method according to the invention advantageously comprises a supplementary step of adsorption on activated carbon, said step allowing a reduction in the micropollutant content of said water. The present invention thus makes it possible to reduce the residual organic matter content at the entry to the step of adsorption on activated carbon. The dosings of activated carbon are thus minimised while ensuring elimination of the residual organic matter and of the micropollutants.

Preferentially, all or part of the concentrate resulting from said nanofiltration step is conveyed to said step of adsorption on activated carbon. When the method is implemented with a two-stage nanofiltration, the concentrate conveyed to the step of adsorption on active carbon can come from these two stages. This makes it possible to increase the overall hydraulic efficiency of the method. This is because nanofiltration produces a concentrate containing organic matter that is a liquid waste. The recovery of a part of this concentrated liquid and the activated carbon treatment thereof therefore makes it possible to reduce the water losses and ultimately to increase the total efficiency of the plant.

According to a variant, the supplementary adsorption step is implemented in the presence of ozone. The ozone, intended to degrade the micropollutants adsorbed on the activated carbon, will thus be able to be injected directly into the reactor accommodating the activated carbon or, according to an alternative, in a concentrate conveyed to said reactor.

According to a variant of the invention, the nanofiltration membranes used are polyether sulfone membranes. This material is compatible with the use of high levels of free chlorine of between 200 ppm and 1000 ppm, limiting the risk of biofouling that is often present because of the high proportion of natural organic matter in the water to be treated.

Preferentially, said nanofiltration step is implemented without any recirculation of concentrate at the membrane head. In this case, the nanofiltration membranes used preferentially have a salt retention rate of less than 15%, i.e. they do not retain more than 15% of the salt concentration of the liquid that they filter.

In this regard, it should be noted that, in the methods for making water drinkable of the prior art implementing membrane filtration by nanofiltration and/or reverse osmosis, it is conventional to reroute part of the concentrate produced at the membrane head with a view to increasing the conversion rate of said membranes. The main purpose of such recirculation is to discharge the salts retained by the surface of the membranes in order to avoid the accumulation of these salts on the surface thereof. This is because a high concentration of such salts on the surface of the membranes may cause precipitation thereof and greatly impair the filtration performance of said membranes. In addition, when the method is stopped, the presence on the one hand of the membranes with a permeate having a low salt concentration and on the other hand a highly-concentrated limit layer of salts subjects the membranes to an osmotic pressure that may exceed the mechanical strength thereof and thus cause rupture thereof.

By using membranes that retain salts only a little, in practice not retaining more than 15% of the salts, it is possible, in the context of the present invention, to dispense with such recirculation of concentrate at the membrane head. Such an absence of recirculation affords significant advantages. Firstly, it affords a saving in the energy necessary for recirculation, and thus gives rise to a reduction in the energy consumption of the method that may range up to 25%. Secondly, it allows a reduction in the membrane surface necessary for producing the same quantity of water. Without recirculation the water in fact does not need to be refiltered. Thus this absence of recirculation of the concentrate makes it possible to reduce both the cost of constructing the plant and the costs of using this and the operating costs.

In the context of the present invention, nanofiltration membranes that retain the salts only a little will therefore preferentially be selected. Nanofiltration membranes, in particular those made from polyether sulfones, when sold, generally indicate a high salt retention level. The inventors therefore had to implement numerous tests before finding membranes suitable for this preferential variant of the invention, having a salt retention level below 15%.

### LIST OF FIGURES

The invention, as well as the various advantages that it presents, will be understood more easily by means of the following description of embodiments thereof given by way of illustration and non-limitatively, with reference to the drawings, wherein:

FIG. 1 shows schematically a first embodiment of a plant for implementing the method according to the invention;

FIG. 2 shows schematically a second embodiment of a plant for implementing the method according to the invention;

FIG. 3 shows schematically a third embodiment of a plant for implementing the method according to the invention;

FIG. 4 shows schematically a third embodiment of a plant for implementing the method according to the invention;

FIG. 5 is a curve showing the maintenance over time of the permeability of the nanofiltration membranes of the plant shown in FIG. 4;

FIG. 6 is a curve relating to the elimination of the salts by the nanofiltration membranes of the plant shown in FIG. 4;

FIG. 7 is a curve relating to the reduction of the alkalinity of the water filtered by the nanofiltration membranes of the plant shown in FIG. 4.

### DESCRIPTION OF EMBODIMENTS

With reference to FIG. 1, a plant for implementing the method according to the invention comprises an inlet 1 for raw water to be treated, a screening module D comprising a sieve having a cut-off capacity of 30 μm, a first membrane filtration module comprising an ultrafiltration or microfiltration membrane 0 and a membrane filtration module comprising a nanofiltration membrane 2 that filters the permeate coming from said ultrafiltration or microfiltration membrane.

The total hydraulic efficiency of such a membrane system is greater than 90%. The screening and microfiltration or ultrafiltration afford a pretreatment of the water with a view to eliminating therefrom the particulate or colloidal pollution. These steps thus make it possible to dispense with the use of any coagulant or flocculant and of any settling or filtration on granular material (sand, anthracite or pumice stone conventionally used) of the water upstream of the nanofiltration step. As for the nanofiltration, this affords a reduction in dissolved compounds such as dissolved organic matter, and in particular those responsible for the colour of the water.

With reference to FIG. 2, a plant for implementing the method according to the invention comprises a pretreated-water inlet 1, a membrane filtration module comprising a nanofiltration membrane 2, a reactor containing activated carbon 3, and a filtered-water outlet 4. A pipe 5 for discharging the concentrate produced by the membrane is connected to a pipe 6 for conveying part of this concentrate to the permeate-discharge pipe 7, this pipe conveying this mixture to the activated-carbon reactor 3. According to this embodiment, the nanofiltration is organised in a single stage. The hydraulic efficiency of such a membrane system is 98.5%, corresponding to a loss of water of only 1.5%.

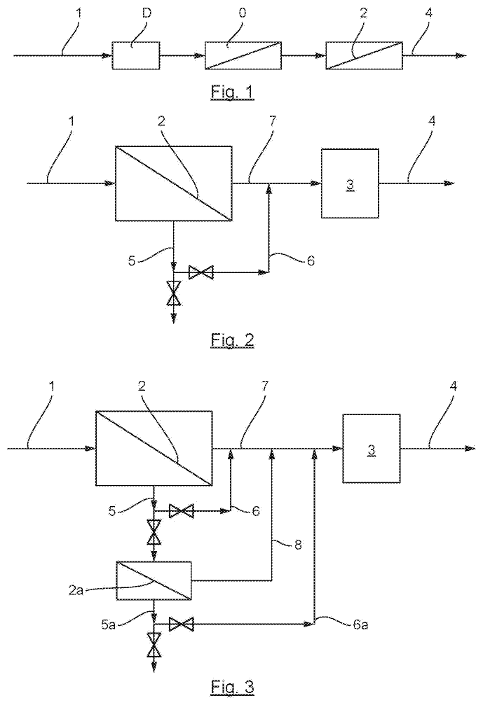

According to FIG. 3, the third embodiment of a plant for implementing the method according to the invention comprises two nanofiltration stages mounted in series. According to this FIG. 3, two membrane filtration units each comprise a nanofiltration membrane 2, 2a. The concentrate produced by the first membrane 2 is partly treated by the second membrane 2a. The other part is mixed with the permeate produced by this first membrane 2. The permeate produced by the second membrane is mixed with the permeate produced by the first membrane. The concentrate produced by the second membrane is partly discharged through a pipe 5a to the natural environment, while the other part of this concentrate is conveyed by a pipe 6a to the pipe 7 for discharging the permeate from said first membrane in order to be mixed with this permeate. The total permeate is next conveyed by a pipe 8 to a step 3 of adsorption on activated carbon. The hydraulic efficiency of such a membrane system is greater than 99%.

According to FIG. 4, a fourth embodiment of a plant for implementing the method according to the invention is shown.

This plant implements a first microfiltration step (M) followed by an ultrafiltration step (U) followed by a nanofiltration step.

The microfiltration membranes have a cut-off threshold of 0.5 μm. As for the ultrafiltration membranes, these have a cut-off threshold of 0.02 μm.

The nanofiltration step comprises two stages (NF 1, NF 2) mounted in series. Each filtration stage is equipped with three nanofiltration membranes each having a membrane surface of 37 m². The plant thus develops a total nanofiltration surface of 222 m².

In this plant, the water, after a safety filtration during the microfiltration step (M), and after having been ultrafiltered during the ultrafiltration step (U), is conveyed to the first nanofiltration stage (NF1) at a conversion rate of 50%, which means that 100% of the volume of the water to be treated makes it possible to obtain 50% permeate volume and 50% concentrate volume. The concentrate produced by this first filtration stage (NF1) is conveyed in its entirety to the second filtration stage (NF2) in order to be filtered therein at a conversion rate of 90%, which means that 100% of the concentrate volume of the first filtration stage makes it possible to obtain 90% permeate volume and 10% concentrate volume. The concentrate produced by the second filtration stage is discharged through a pipe to the natural environment.

The permeates coming from the first and second nanofiltration stages are mixed.

Finally, the conversion rate of the nanofiltration step is 95%, which means that 100% of the volume of the water to be treated entering this step makes it possible to obtain 95% by volume permeate and 5% by volume concentrate.

In these four embodiments, the nanofiltration membranes used are sulfonated polyether sulfone membranes sold by the company Hydranautics under the name HydraCoreRe 50 LD. These membranes have a cut-off capacity of 1000 Da.

This cut-off threshold of 1000 Da is in fact sufficiently fine for treating the organic matter and the colour of the water but sufficiently high not to change the mineralisation of the water, eliminating the need for remineralising the water following the treatment. The nanofiltration membrane used allows ions to pass, which helps to reduce the supply pressure and thereby to reduce the energy consumption. In conventional nanofiltration, the supply pressure is 10 bar (NF 90 at a temperature of 15° C. and conversion rate of 85% with three filtration stages), which gives rise to an energy consumption of 365 W·h/m³ of treated water. With the open nanofiltration membrane used in the context of the present invention having a cut-off threshold of 1000 Da, the supply pressure is only 5 bar (at a temperature of 15° C. and a conversion rate of 95%).

The energy consumption is thus reduced to 150 W·h/m³ of treated water. Table 1 below indicates the reductions in the colour, turbidity and dissolved organic matter parameters obtained by means of the overall treatment system shown in FIG. 1.

TABLE 1

| Parameter | Reduction |
|---|---|
| Actual colour (Pt/Co) | >97% |
| Absorbance (UV 254 nm) | >95% |
| COD | >90% |

Table 2 below presents the quality parameters of the water before and after treatment by nanofiltration followed by the activated-carbon reactor according to the invention by means of the plant shown in FIG. 2.

TABLE 2

| | | | Output of |
|---|---|---|---|
| | Raw-water | Recirculated | permeate |
| | inlet rate: | concentrate rate: | produced: |
| | 100 m³/h | 3.5 m³/h | 98.5 m³/h |
| Colour mg/l | 30 | 480 | <3 |
| COD mg/l | 6 | 70 | <2.0 |
| Micropollutant μg/l | 2 | 2 | <0.1 |

These results demonstrate the efficacy of the treatment according to the invention for reducing the organic matter and the colour. The organic matter content is reduced by more than 65%. The colour content is reduced by more than 90%. The reduction in the water losses while maintaining a quality of water produced in accordance with the standards is thus noted. The water losses can be less than 1% if the COD concentration is for example less than 4 mg/I at the nanofiltration input, which makes it possible to recycle the major part of the concentrate.

The plant shown in FIG. 4 was tested over a period of three months. During this period no chemical reagent was added and the membranes did not benefit from any chemical or mechanical cleaning.

To monitor the development of the clogging of the nanofiltration membranes, the permeability thereof was measured continuously. In this context, the permeability of the membranes was calculated by dividing the flow corrected to 20° C. (expressed in L/h·m²) by the transmembrane pressure necessary for filtration.

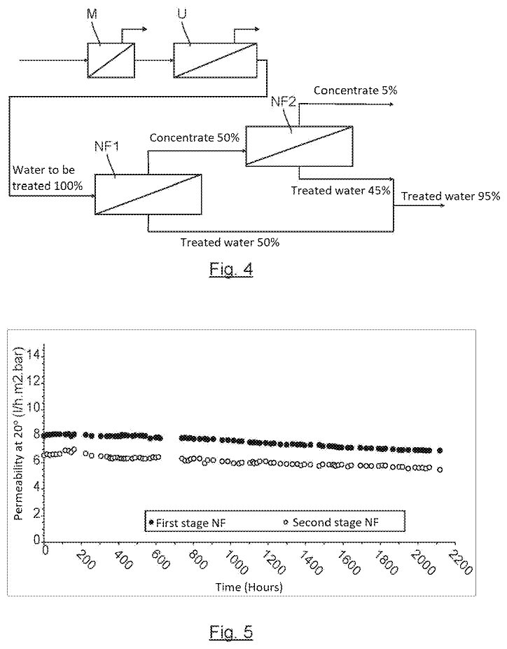

The results as set out in FIG. 5 indicate that the permeability of the nanofiltration membranes of the plant could be maintained over the whole of the test period without adding chemical reagents, such as in particular anti-scaling agent, and without chemical or mechanical cleaning of the membranes. Thus, during this period of three months, the conversion rate of the plant could be maintained between 94 and 98%.

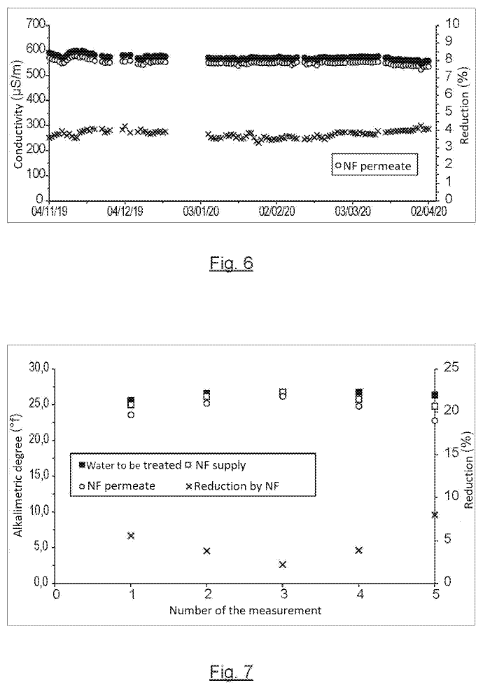

During the test period, i.e. 3 months, the conductivity of the water to be treated and of the nanofiltered water was measured and the rate of retention of the salts contained in this water by the nanofiltration membranes was calculated. The results of these measurements are set out in FIG. 6, on which the data for tests appears on the X axis, the conductivity of the water expressed in μS/m appears on the left-hand Y axis and the rate of retention of the salts expressed as % appears on the right-hand Y axis. These results indicate that the nanofiltration membranes used retain the salts very little, in practice approximately only 4%.

Also, the alkalinity levels of the water to be treated and of the nanofiltered water were regularly measured five times over the entire test period and the rate of retention of alkalinity in this water by the filtration membranes was calculated. The results of these measurements are set out on FIG. 7, on which the order of the five measurements made appear on the X axis, the alkalimetric titre of the water expressed in French degrees (°f) appears on the left-hand Y axis and the degree of reduction of alkalinity expressed as % appears on the right-hand Y axis. These results indicate that the nanofiltration membranes used retain very little the alkalinity of the treated water, in practice on average barely 5%.

1-11. (canceled)

12. Method for making surface water drinkable, aimed at reducing the suspended matter content thereof, the turbidity thereof, the organic matter content thereof and the colour thereof, characterised in that it comprises:
a step of nanofiltration of said water through at least one nanofiltration membrane having a cut-off capacity between 800 Da and 2000 Da,
said nanofiltration step leading to obtaining a permeate and a concentrate, wherein said nanofiltration step is implemented with a conversion rate greater than 95%,
said method being carried out in the absence of any step of adding anti-scaling agent or any step of remineralising said permeate.

13. Method according to claim 12, characterised in that said nanofiltration step is implemented in a nanofiltration plant comprising a single stage.

14. Method according to claim 12, characterised in that said nanofiltration step is implemented in a nanofiltration plant comprising two stages mounted in series.

15. Method according to claim 12, characterised in that it comprises at least one preliminary step of microfiltration or ultrafiltration of said water, prior to said nanofiltration step, said preliminary step being implemented through at least one microfiltration or ultrafiltration membrane having a cut-off capacity between 10 nm and 1 μm, said ultrafiltration step or said nanofiltration step being implemented with a total conversion rate greater than 90%.

16. Method according to claim 15, characterised in that it comprises a sieving step provided upstream of said microfiltration or ultrafiltration, said sieving step being implemented with a cut-off capacity between 20 μm and 200 μm, and said method then being implemented in the absence of any addition of coagulant and/or flocculant.

17. Method according to claim 12, characterised in that it comprises a supplementary step of adsorping micropollutants on activated carbon, said step enabling the micropollutants content in said water to be reduced.

18. Method according to claim 17, characterised in that all or part of said concentrate resulting from said nanofiltration step is conveyed to said step of adsorping micropollutants on activated carbon.

19. Method according to claim 17, characterised in that the adsorption step is implemented in the presence of ozone.

20. Method according to claim 12, characterised in that said at least one nanofiltration membrane is made from polyether sulfone.

21. Method according to claim 12, characterised in that said nanofiltration step is implemented without any recirculation of concentrate.

22. Method according to claim 21, characterised in that said at least one nanofiltration membrane has a degree of retention of salts of less than 15%.

23. A method of treating surface water and converting surface water to drinkable water, comprising:
collecting the surface water;
subjecting the surface water to a treatment process and reducing the suspended matter, organic matter and turbidity in the surface water;
wherein the treatment process includes:
directing the surface water to a nanofiltration membrane unit having a cutoff capacity between 800 Da and 2,000 Da;
wherein the nanofiltration membrane unit produces a permeate and a concentrate; and
operating the nanofiltration membrane unit so as to convert more than 95% of the surface water directed to the nanofiltration unit to drinkable water in the form of the permeate, while the method is carried out in the absence of any step of adding an anti-scaling agent or any step of remineralizing the permeate.

24. The method of claim 23 including, prior to directing the surface water into the nanofiltration membrane unit, directing the surface water through a sieve having a cutoff capacity of 30 μm.

25. The method of claim 23 wherein, prior to directing the surface water to the nanofiltration membrane unit, removing particulate or colloidal pollution from the surface water by directing the surface water through a microfiltration or ultrafiltration unit and wherein the method is carried out in the absence of adding a coagulant or a flocculant to the surface water.

26. The method of claim 23 including splitting the concentrate produced by the nanofiltration membrane unit into first and second streams and mixing the first stream of the concentrate with the permeate produced by the nanofiltration membrane unit; after mixing the first stream of the concentrate with the permeate, directing the permeate-concentrate mixture to an activated carbon unit for treatment.

27. The method of claim 23 further including directing the concentrate from the nanofiltration unit to a second nanofiltration unit and producing a second permeate and a second concentrate and mixing the second permeate with the permeate produced by the nanofiltration unit; and splitting the second concentrate into first and second streams and mixing the first stream of the second concentrate with the permeate produced by the nanofiltration unit and the second permeate.

28. The method of claim 27 wherein the permeate, second permeate, and the first stream of the second concentrate form a mixture, and the method includes directing the mixture to an activated carbon unit for treatment.

29. A method of treating surface water and converting the surface water to drinkable water comprising:
directing the surface water through a microfiltration unit and producing a first permeate and a first concentrate;
directing the first permeate through an ultrafiltration unit and producing a second permeate and a second concentrate;
directing the second permeate to a first nanofiltration membrane unit and producing a third permeate and a third concentrate;
directing the third concentrate through a second nanofiltration membrane unit and producing a fourth permeate and a fourth concentrate; and
combining the third and fourth permeates to form drinkable water where the drinkable water represents at least a 95% recovery level compared with the second permeate directed into the first nanofiltration membrane unit.

30. The method of claim 29 wherein the method is carried out without the addition of any chemical reagents.
